(19) United States
(12) Patent Application Publication
(10) Pub. No.: US 2009/0046176 A1
(43) Pub. Date: Feb. 19, 2009

(54) VIDEO SIGNAL PROCESSING APPARATUS

(75) Inventor: Kenji Tabei, Kanagawa (JP)

Correspondence Address: PEARNE & GORDON LLP, 1801 EAST 9TH STREET, SUITE 1200, CLEVELAND, OH, 44114-3108, US

(73) Assignee: MATSUSHITA ELECTRIC INDUSTRIAL CO., LTD., Osaka (JP)

(21) Appl. No.: 11/577,342

(22) PCT Filed: Oct. 14, 2005
(86) PCT No.: PCT/JP05/18968

§ 371 Date: Apr. 16, 2007

(30) Foreign Application Priority Data
Oct. 18, 2004 (JP) 2004-302747

(51) Int. Cl. H04N 5/262

(52) U.S. Cl. 348/240.99; 348/E05.051

(57) ABSTRACT

It is an object of the present invention to provide a video signal processing apparatus that can be reduced in production cost, and perform an electronic zooming function. In the video signal processing apparatus, a noise reduction of and a gain adjustment of the video signal from the imaging element 12 is performed by the analog preprocessing means 13. The video signal from the analog preprocessing means 13 is then converted into a digital signal by the A/D converter 14 in synchronization with the horizontal sync signal and its clock signal. The luminance and color difference signals are produced from the digital signal by the Y/C signal processing means 15, and delayed by the line delay means 16 on the basis of the period of the horizontal sync signal. The interpolating means 18 performs the vertical pixel interpolation process, on the basis of the vertical interpolation coefficient outputted by the zooming control means 17, by using the output signal of the Y/C signal processing means 15 and the output signal of the line delay means 16, and performs the horizontal pixel interpolation process, on the basis of the horizontal interpolation coefficient outputted by the zooming control means 17, by using pixels horizontally-adjacent to each other.

### TECHNICAL FIELD OF THE INVENTION

The present invention relates to a video signal processing apparatus for performing an electronic zooming process on a video signal.

### DESCRIPTION OF THE RELATED ART

The conventional video signal processing apparatus, such as for example a video camera, is adapted to zoom in, and to zoom out a video image taken by a solid-state image sensing device such as for example Charge-Coupled Device (CCD), by processing a video signal indicative of the video image (see, for example, a patent document 1).

FIG. 13 is a block diagram showing the conventional video signal processing apparatus for performing an electronic zooming operation.

As shown in FIG. 13, the conventional imaging apparatus comprises a lens 51 having a lens, a diaphragm, and a filter, a charge coupled device (CCD) 52 functioning as an imaging element, a video signal processing circuit 53 having a gamma-correction circuit, a low-pass filter and a clipping circuit, an analog-to-digital converter (ADC) 54 for converting an analog signal to a digital signal, a frame memory 55 for storing a video signal of each frame, an interpolation circuit 56 for performing an interpolation of each image, an edge enhancing circuit 57 for enhancing an image, a digital-to-analog converter (DAC) 58 for converting the digital signal into an analog signal, a recording circuit 59 for recording an image signal, a write address controller 60 for designating a write address of the frame memory 55, a read address controller 61 for designating a read address of the frame memory 55, a T/W switch 62 for selectively setting telescopic and wide-angle modes, and a magnification generating circuit 63 for generating, on the basis of the mode set by the T/W switch 62, a magnification at which the electronic zooming function is performed.

In the conventional imaging apparatus thus constructed, the frame memory 55, the write address controller 60, the read address controller 61, the interpolation circuit 56, the magnification generating circuit 63 collectively perform an electronic zooming function.

In this imaging apparatus, the signal from the A/D converter 54 is stored in the frame memory 55 on the basis of the write address designated by the write address controller 60. When the signal from the A/D converter 54 is stored in the frame memory 55 in each frame, the read address controller 61 generates read address on the basis of the magnification generated by the magnification generating circuit 63. The signal is read from the frame memory 55 on the basis of the generated read address.

The imaging apparatus can output an image signal indicative of an image zoomed at a designated magnification by reason that the signal read from the frame memory 55 is processed by the interpolation circuit 56 on the basis of the magnification designated by the magnification generating circuit 63.

patent document 1: Jpn. unexamined patent publication No. H07-170461

### DISCLOSURE OF THE INVENTION

### Problems To Be Solved By the Invention

The conventional imaging apparatus, however, encounters such a problem that it is necessary to use a frame memory for storing an image for each frame. This leads to the fact that the conventional imaging apparatus is increased in production cost by reason that the frame memory is generally expensive, and increased in size by reason that the number of its components is increased.

It is, therefore, an object of the present invention to provide a video signal processing apparatus that can be improved in production cost, and perform an electronic zooming function.

### Means For Solving the Problems

The video signal processing apparatus according to the present invention, comprising: line delay means for delaying a video signal by a period of a horizontal scan; and interpolating means for performing a vertical interpolation by using the video signal and the video signal delayed by the line delay means, performing a horizontal interpolation by using pixels adjacent to each other, and outputting an effective flag indicating an effective section of a signal to be outputted.

The video signal processing apparatus thus constructed as previously mentioned according to the present invention can perform an electronic zooming function without using a frame memory by reason that the horizontal and vertical interpolations are separately performed by the interpolating means, and the vertical interpolation is performed in each line.

The video signal processing apparatus according to the present invention further comprises signal processing means for performing a vertical interpolation by using at least two lines including a relevant line and an adjacent line, performing a horizontal interpolation by using pixels including a relevant pixel and an adjacent pixel, and outputting an effective flag indicating an effective section of a signal to be outputted.

The video signal processing apparatus thus constructed as previously mentioned according to the present invention can zoom in, and zoom out an image by performing an electronic zooming operation at a designated magnification, and by performing through an interpolating process and a signal process.

The video signal processing apparatus, comprising: video signal outputting means for outputting a video signal in synchronization with vertical and horizontal synchronization signals; line delay means for delaying the video signal by a period of the horizontal synchronization signal; interpolating means for performing a vertical pixel interpolation by comparing the video signal outputted by the video signal outputting means and the video signal delayed by the line delay means; and zooming control means for controlling the interpolating means on the basis of a vertical magnification ratio to have the interpolating means perform the vertical pixel interpolation by using pixels vertically-adjacent in each pixel.

The video signal processing apparatus thus constructed as previously mentioned according to the present invention can performing the vertical interpolation in each pixel without using a frame memory.

In the video signal processing apparatus according to the present invention, the interpolating means is adapted to perform, for an image interpolated in the vertical direction, a horizontal pixel interpolation by using pixels horizontally-adjacent to each other, and the zooming control means is adapted to control the interpolating means on the basis of a horizontal magnification to have the interpolating means perform the horizontal pixel interpolation by using two pixels horizontally-adjacent to each other.

The video signal processing apparatus thus constructed as previously mentioned according to the present invention can performing the horizontal pixel interpolation without using a frame memory.

In the video signal processing apparatus according to the present invention, the zooming control means is adapted to have the interpolating means perform the horizontal pixel interpolation by using pixels horizontally-adjacent to each other before the video signal is delayed by the line delay means.

The video signal processing apparatus thus constructed as previously mentioned according to the present invention can performing the vertical pixel interpolation after performing the horizontal pixel interpolation.

In the video signal processing apparatus according to the present invention, the interpolating means includes vertical interpolation means for producing a video signal indicative of the image interpolated in the vertical direction, and horizontal interpolation means for producing a video signal indicative of the image interpolated in the horizontal direction, and the zooming control means includes vertical zooming control means for allowing a vertical line effective flag to indicate whether or not each of sample points of the video signal produced by the vertical interpolation means is within an active period, horizontal zooming control means for allow a horizontal line effective flag to indicate whether or not each of sample points of the video signal produced by the horizontal interpolation means is within an active period, and a logical product circuit for outputting, in synchronization with video signal produced by the horizontal interpolation means, an effective flag signal indicative of the logical product of the vertical and horizontal line effective flags.

The video signal processing apparatus thus constructed as previously mentioned according to the present invention can performing independently the vertical and horizontal pixel interpolations.

In the video signal processing apparatus according to the present invention, the vertical zooming control means is adapted to calculate a vertical interpolation coefficient from the vertical magnification ratio, the vertical interpolation means includes a first multiplier for multiplying the video signal delayed by the line delay means by the vertical interpolation coefficient, a second multiplier for multiplying the video signal outputted by the video signal outputting means by a complement number of the vertical interpolation coefficient, and an adder for producing a video signal indicative of the sum of the video signal multiplied by the vertical interpolation coefficient and the video signal multiplied by the complement number of the vertical interpolation coefficient, and the vertical zooming control means is adapted to allow the vertical interpolation means to output, in synchronization with the vertical and horizontal sync signals, the video signal produced by the adder to the horizontal interpolation means.

The video signal processing apparatus thus constructed as previously mentioned according to the present invention can performing simply the vertical interpolation by using the vertical interpolation coefficient calculated from the vertical magnification.

In the video signal processing apparatus, the horizontal zooming control means is adapted to calculate a horizontal interpolation coefficient from the horizontal magnification, the horizontal interpolation means includes pixel delay means for delay the video signal received from the vertical interpolation means, a first multiplier for multiplying the video signal received from the vertical interpolation means by the horizontal magnification coefficient, a second multiplier for multiplying the video signal delayed by the pixel delay means by a complement number of the horizontal magnification coefficient, and an adder for producing a video signal indicative of the sum of the video signal multiplied by the horizontal magnification coefficient and the video signal multiplied by the complement number of the horizontal magnification coefficient, and the vertical zooming control means is adapted to allow the horizontal interpolation means to output, in synchronization with the vertical and horizontal sync signals, the video signal produced by the adder of the horizontal interpolation means.

The video signal processing apparatus thus constructed as previously mentioned according to the present invention can performing simply the horizontal interpolation by using the horizontal interpolation coefficient calculated from the horizontal magnification.

In the video signal processing means according to the present invention, the line delay means is constituted by line memory means having three banks, each of which stores one line of an image to be represented by the video signal, the line memory means is adapted to store the image in the three banks through steps of writing sequentially three lines of the image in the respective banks before overwriting sequentially the next three lines of the image in the respective banks, and overwriting repeatedly in each frame until writing the last line of the image is any one of the banks, the line memory means is adapted to read, when writing one line of the image in any one of the banks, two lines from the remaining two banks, and to output the two lines to the interpolating means, and the interpolating means is adapted to the vertical pixel interpolation by using two pixels of the two lines read by the line memory means.

The video signal processing apparatus thus constructed as previously mentioned according to the present invention can performing simply the horizontal pixel interpolation by using pixels adjacent to each other by reason that the line memory means is adapted to store the image in the three banks through steps of writing sequentially three lines of the image in the respective banks before overwriting sequentially the next three lines of the image in the respective banks, and overwriting repeatedly in each frame until writing the last line of the image is any one of the banks.

In the video signal processing apparatus according to the present invention, the zooming control means is adapted to have the line memory means store the video signal after having the interpolating means perform the horizontal pixel interpolation by using pixels adjacent to each other.

The video signal processing apparatus thus constructed as previously mentioned according to the present invention can change the order of the horizontal and vertical interpolations.

### Advantageous Effect of the Invention

The present invention provides a video signal processing apparatus that can be improved in production cost, and perform an electronic zooming function, without using a frame memory, by performing the vertical interpolation by using the inputted line and the line delayed by the line delay means, and perform performing the horizontal interpolation by using pixels adjacent to each other.

### BRIEF DESCRIPTION OF THE DRAWINGS

FIG. 1 is a block diagram showing the first embodiment of the video signal processing apparatus according to the present invention.

FIG. 2 is a timing chart showing the sync signal from the video signal processing apparatus according to the first embodiment of the present invention and the output signal from the imaging element.

FIG. 3 is a block diagram showing the interpolating means and the zooming control means of the video signal processing apparatus according to the first embodiment of the present invention.

FIG. 4 is a block diagram showing the vertical interpolation means of the video signal processing apparatus according to the first embodiment of the present invention.

FIG. 5 is a timing chart showing the vertical interpolation to be performed by the vertical interpolation means of the video signal processing apparatus according to the first embodiment of the present invention.

FIG. 6 is a block diagram showing the horizontal interpolation means of the video signal processing apparatus according to the first embodiment of the present invention.

FIG. 7 is a timing chart showing the horizontal interpolation to be performed by the horizontal interpolation means of the video signal processing apparatus according to the first embodiment of the present invention.

FIG. 8 is a timing chart showing the output signal of the video signal processing apparatus according to the first embodiment of the present invention, the output signal being indicative of an electronically-zoomed image.

FIG. 9 is a block diagram showing the video signal processing apparatus according to the second embodiment of the present invention.

FIG. 10 is a block diagram showing the interpolating means of the video signal processing apparatus according to the second embodiment of the present invention.

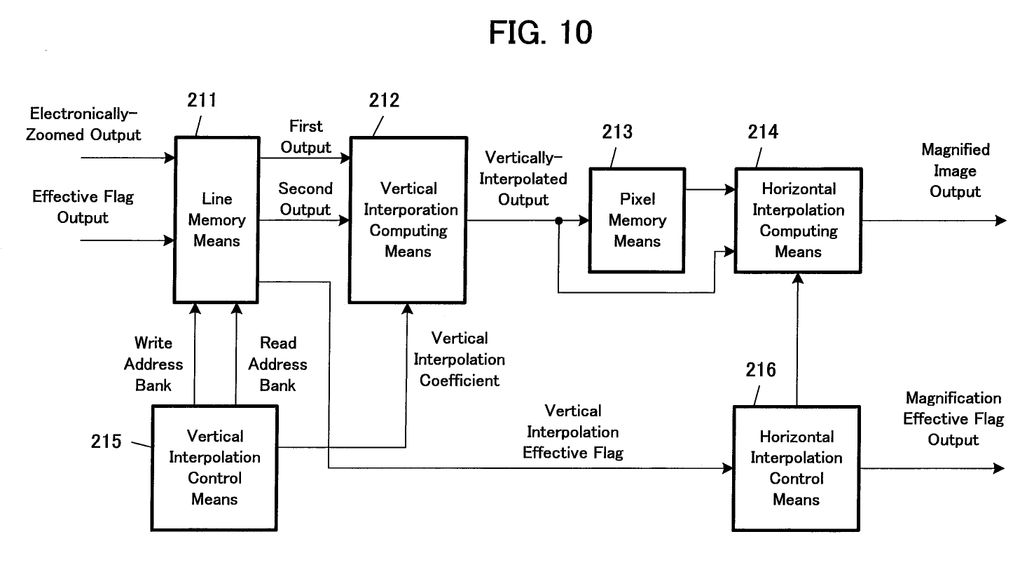

FIG. 11 is a timing chart showing the vertical interpolation to be performed by the video signal processing apparatus according to the second embodiment of the present invention.

FIG. 12 is a timing chart showing the horizontal interpolation to be performed by the video signal processing apparatus according to the second embodiment of the present invention.

FIG. 13 is a block diagram showing the conventional imaging apparatus.

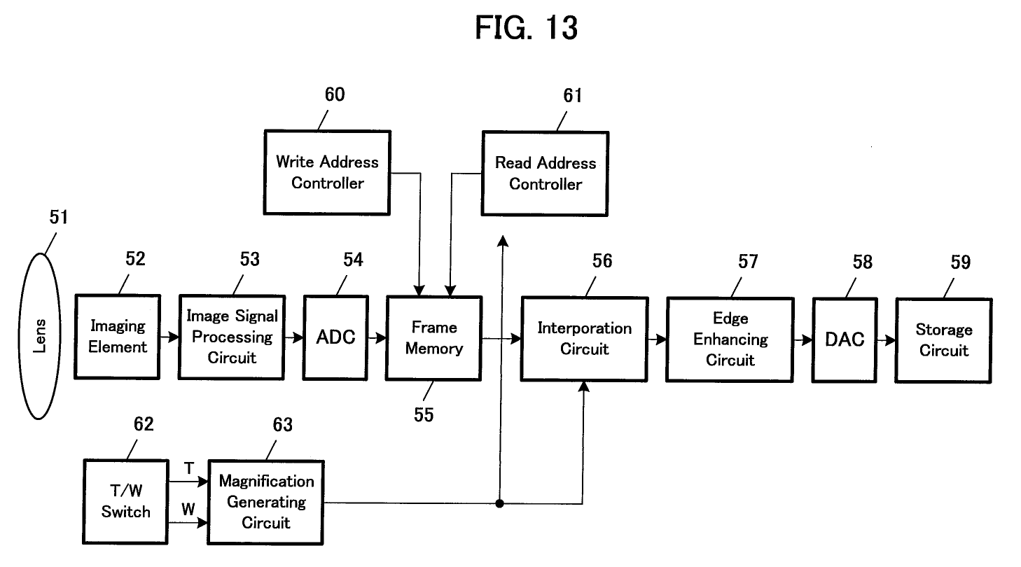

### EXPLANATION OF THE REFERENCE NUMERALS

11: lens
12: imaging element
13: analog preprocessing means
14: analog-to-digital converter (A/D converter)
15: Y/C signal processing means
16: line delay means
17: zooming control means
18: interpolating means
19: imaging element driving means
21: signal processing means
171: vertical zooming control means
172: horizontal zooming control means
173: logical product circuit
181: vertical interpolation means
181a: calculating unit
181b: first multiplier
181c: second multiplier
181d: adder
182: horizontal interpolation means
182a: calculating unit
182b: first multiplier
182c: pixel delay means
182d: second multiplier
182e: adder
211: line memory means
212: vertical interpolation computing means
213: pixel memory means
214: horizontal interpolation computing means
215: vertical interpolation control means
216: horizontal interpolation control means
51: lens
52: CCD
53: video signal processing circuit
54: A/D converter (ADC)
55: frame memory
56: interpolating circuit
57: emphasis circuit
58: D/A converter (DAC)
59: memory circuit
60: write address controller
61: read address controller
62: T/W switch
63: magnification generating circuit

### DESCRIPTION OF THE PREFERRED EMBODIMENTS

The embodiments of the video signal processing apparatus according to the present invention will be described hereinafter with reference to accompanying drawings.

### First Embodiment

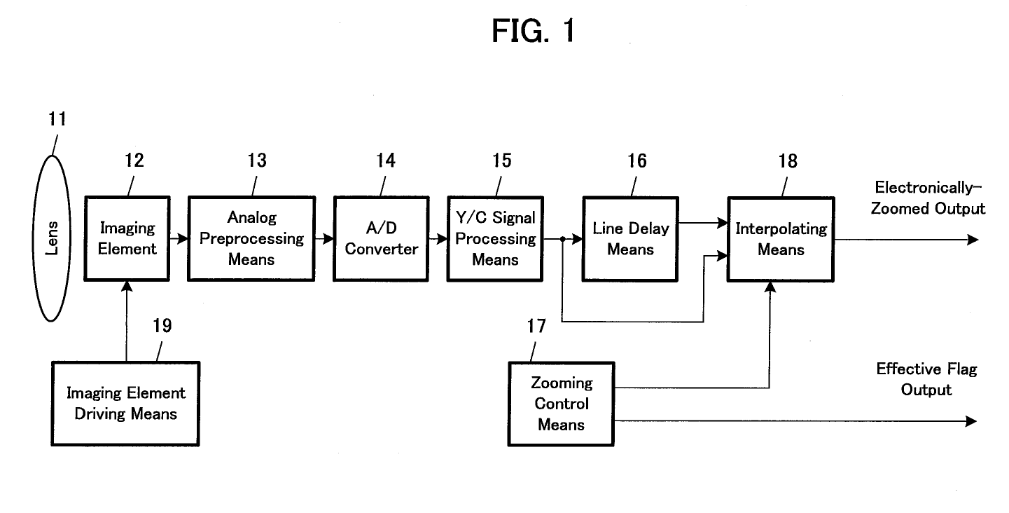

FIG. 1 is a block diagram showing the first embodiment of the video signal processing apparatus according to the present invention.

As shown in FIG. 1, the video signal processing apparatus according to the first embodiment of the present invention comprises a lens 11 for focusing light and providing an image at a predetermined position by adjusting focus, an imaging element 12 for converting the light focused by the lens 11 to an electric signal, and producing an analog video signal indicative of the image provided by the lens 11, analog preprocessing means 13 for performing a noise reduction and an gain adjustment of the analog video signal by processing the analog video signal outputted by the imaging element 12, an analog-to-digital converter (hereinafter referred to as “A/D converter”) 14 for converting the analog video signal processed by the analog preprocessing means 13 into a digital signal, Y/C signal processing means 15 for processing, in luminance and color, the digital signal outputted by the A/D converter 14, imaging element driving means 19 for producing a drive signals (including horizontal and vertical sync signals) to drive the imaging element 12, line delay means 16 for delaying, by a predetermined time, a luminance signal and a color difference signal produced by the Y/C signal processing means 15, interpolating means 18 for interpolating the luminance and color difference signals outputted by the Y/C signal processing means 15, zooming control means 17 for controlling the interpolating means 18, and magnification setting means (not shown) for setting vertical and horizontal magnifications to be needed to perform vertical and horizontal interpolations.

Here, the analog preprocessing means 13, the A/D converter 14, the Y/C signal processing means 15, and the imaging element driving means 19 collectively function as video signal outputting means for outputting a video signal to the line delay means 16 and the interpolating means 18 in synchronization with the vertical and horizontal sync signals.

In this embodiment, the predetermined delay time of the line delay means 16 is the same as the period of the horizontal sync signal (the period of the horizontal scan).

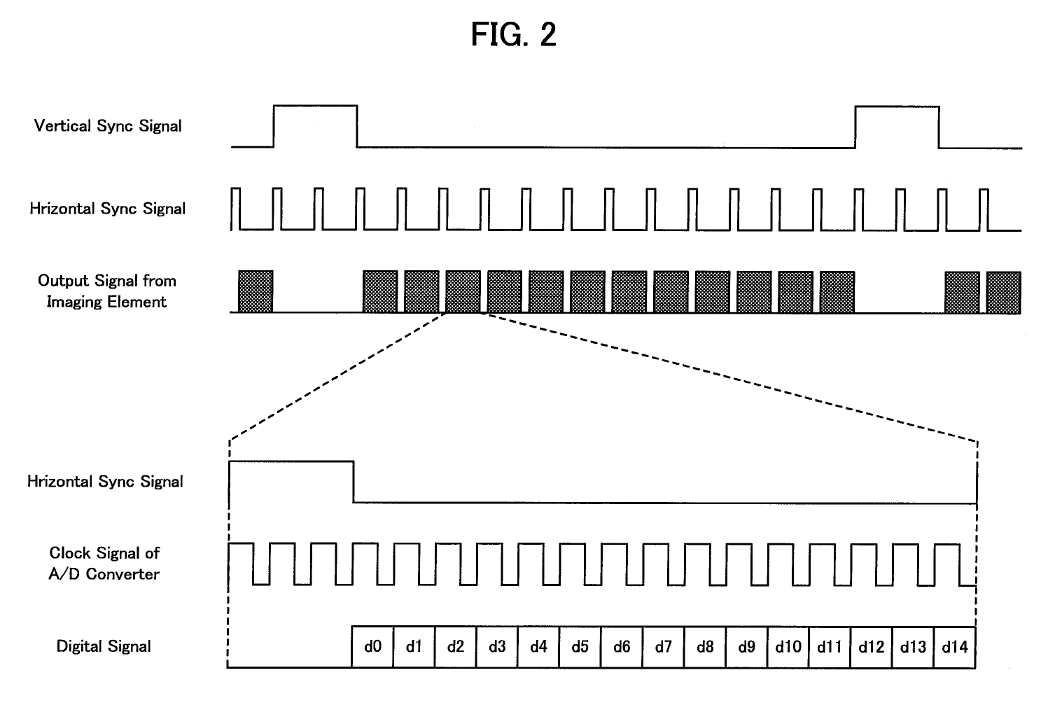

FIG. 2 is a timing chart showing the synchronization of the analog video signal produced by the imaging element 12 to the vertical and horizontal sync signals.

As shown in FIG. 2, the imaging element 12 is adapted to output an analog video signal to the Y/C signal processing means 15 in synchronization with the vertical and horizontal sync signals, while the Y/C signal processing means 15 is adapted to output luminance and color difference signals to the line delay means 16 and the interpolating means 18 in synchronization with the vertical and horizontal sync signals.

The interpolating means 18 is adapted to receive the luminance and color difference signals processed and outputted by the Y/C signal processing means 15 in synchronization with the vertical and horizontal sync signals, and to receive the luminance and color difference signals delayed by the line delay means 16 in synchronization with the vertical and horizontal sync signals. From the foregoing description, it will be understood that the interpolating means 18 can compare, in luminance and color, two pixels adjacent to each other in a vertical direction by receiving the luminance and color difference signals outputted by the Y/C signal processing means 15, and receiving the luminance and color difference signals delayed by a time equal to a period of the horizontal synchronization signal by the line delay means 16.

In this embodiment, the Y/C signal processing means 15 is adapted to produce luminance and color difference signals from the digital video signal of the A/D converter 14. However, the Y/C signal processing means 15 may be adapted to produce red-green-blue signals. The interpolating means 18 may be adapted to perform the interpolation of the red-green-blue signals.

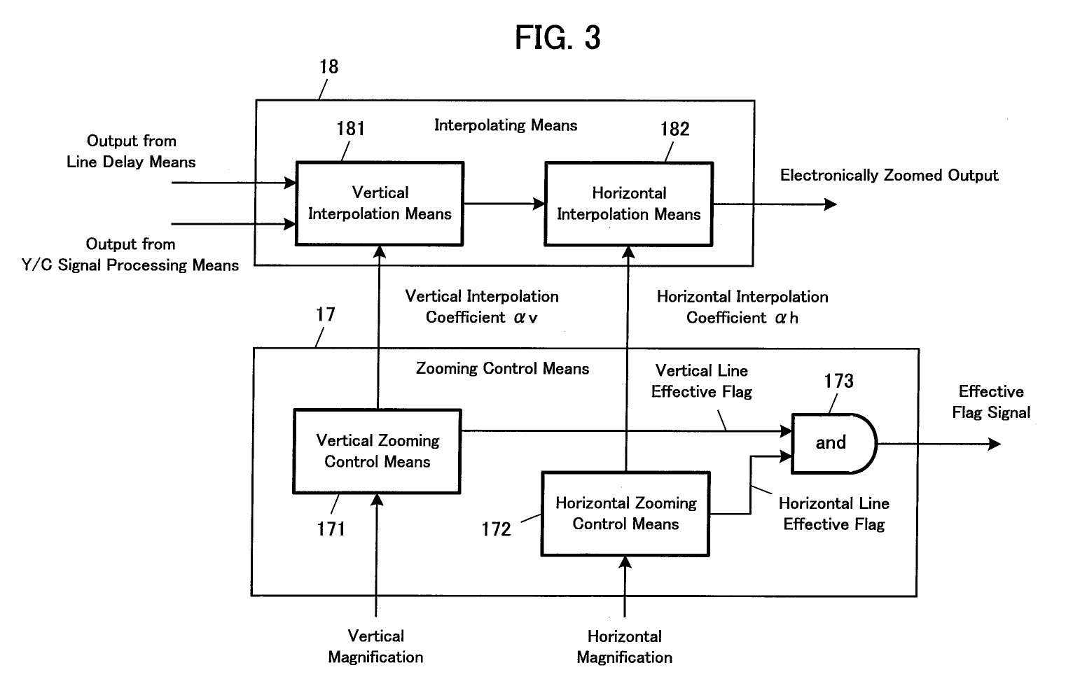

The construction of the zooming control means 17 and the interpolating means 18 of the video signal processing apparatus according to the first embodiment of the present invention will be then described hereinafter with reference to FIG. 3. The type of the video signal will not be specified hereinafter by reason that, even if the video signal is replaced by the red-green-blue signals, the video signal processing apparatus can perform an electronic zooming function by processing the red-green-blue signals or other signals.

In order to perform independently the vertical and horizontal interpolations, the zooming control means 17, as shown in FIG. 3, includes vertical zooming control means 171 for performing a vertical zooming control, horizontal zooming control means 172 for performing a horizontal zoom control, and an a logical product circuit 173 for calculating a logical product of vertical and horizontal effective flags. The interpolating means 18 includes vertical interpolation means 181 for performing vertical interpolation and horizontal interpolation means 182 for performing horizontal interpolation.

The vertical zooming control means 171 and the vertical interpolation means 181 will be described hereinafter as means for performing the vertical interpolation of the image.

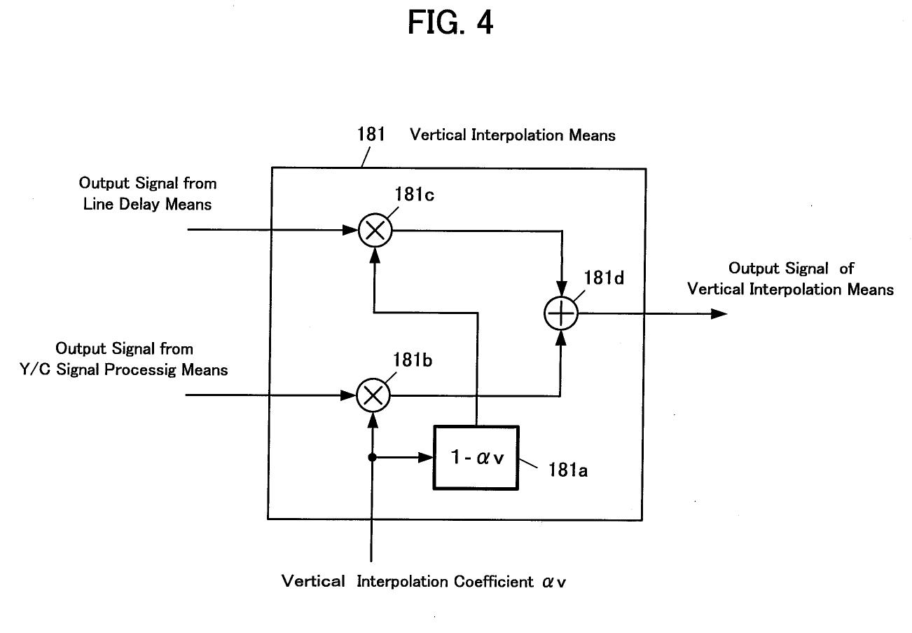

FIG. 4 is a block diagram showing, in further detail, the construction of the vertical interpolation means 181. As shown in FIG. 4, the vertical interpolation means 181 includes a calculating unit 181a for calculating a value 1−αv from an inputted vertical interpolation coefficient αv, a first multiplier 181b for multiplying the output signal from the Y/C signal processing means 15 by the vertical interpolation coefficient αv, a second multiplier 181c for multiplying the output signal from the line delay means 16 by the value 1−αv, and an adder 181d for adding the output of the first multiplier 181b to the output of the second multiplier 181c.

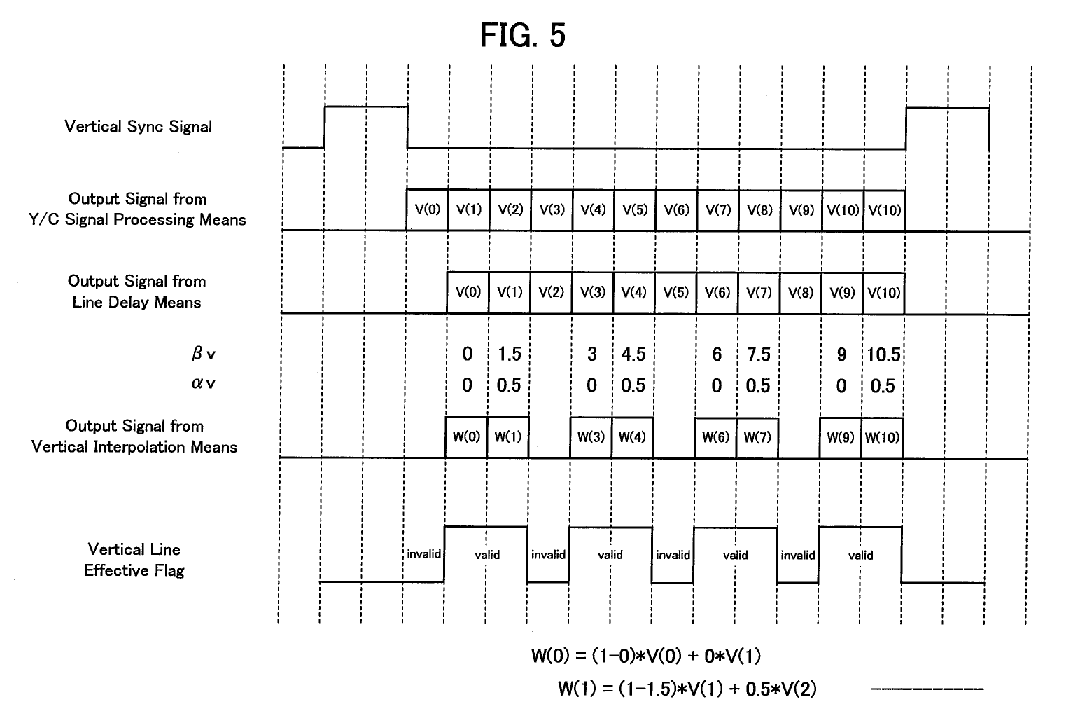

FIG. 5 is a timing chart showing, as one example of the operation to be performed at a vertical interpolation of ⅔ by the video signal processing apparatus, the vertical sync signal, the output signal of the Y/C signal processing means 15, the output signal of the line delaying means 16, the output signal of the vertical interpolation means 181, and the vertical effective flag. Here, the vertical interpolation of ⅔ is intended to indicate the ratio of the input pixels of the vertical interpolation means 181 to the output pixels of the vertical interpolation means 181. In FIG. 5, the twelve effective lines are defined in a vertical scanning period.

In FIG. 5, the reference characters V(0), V(1), . . . , and V(11) are intended to indicate a signal to be inputted into the vertical interpolation means 181, and correspond respective pixels defined as one line. The output signal from the line delay means 16 is late by one line in comparison with the output signal from the Y/C signal processing means 15. The reference characters W(0), W(1), . . . , and W(7) are intended to indicate a signal to be outputted by the vertical interpolation means 181, and correspond respective pixels defined as one line.

The vertical interpolation means 181 is adapted to produce an output signal W(j) (j=0, 1, 2, . . . , 7) from the input signal V(i) (i=0, 1, 2, . . . , 11) by using a following arithmetic expression.

W(j)=(1−αv)×V(int(βv))+αv×V(int(βv)+1)

Here, βv=j/vertical magnification=j×3/2

αv=βv-int(βv)

int(βv) is intended to indicate a function of truncating and outputting an integer.

In this embodiment, the interpolating means 18 is adapted to perform the linear interpolation by using the above-mentioned arithmetic expression. The interpolating means 18 may be adapted to perform the higher-order interpolation of the image.

In order to calculate the output signal W(j), the vertical interpolation means 181 needs to receive the input signal V(int(j/vertical magnification)+1). Therefore, the vertical interpolation means 181 is adapted to calculate the output signal W(j) in response to the input signal V(int(j/vertical magnification)+1). More specifically, it is only necessary to have the vertical interpolation means 181 calculate the output signal W(j) corresponding to a line designated by the input signal V(int(j/vertical magnification)+1). Additionally, it is necessary to have the vertical interpolation means 181 calculate the output signal W(j) in every pixel of the designated line.

It is necessary to indicate whether or not the output signal W(j) of the vertical interpolation means 181 is effective in each line. The vertical zooming control means 171 is adapted to produce a vertical effective flag for indicating whether or not the output signal W(j) of the vertical interpolation means 181 is effective.

The vertical zooming control means 171 is adapted to receive a vertical magnification, to calculate values αv and βv on the basis of the vertical magnification, to produce timing information on whether or not to have the vertical interpolation means 181 perform the calculation of the output signal W(j), and to output the vertical interpolation coefficient αv to the vertical interpolation means 181. When the vertical effective flag is in high level “H”, the vertical effective flag indicates that the relevant line is recognized as an effective line. When, on the other hand, the vertical effective flag is in low level “L”, the relevant line is recognized as an ineffective line.

The horizontal zooming control means 172 and the horizontal interpolation means 182 will be then described hereinafter as means for performing the horizontal interpolation.

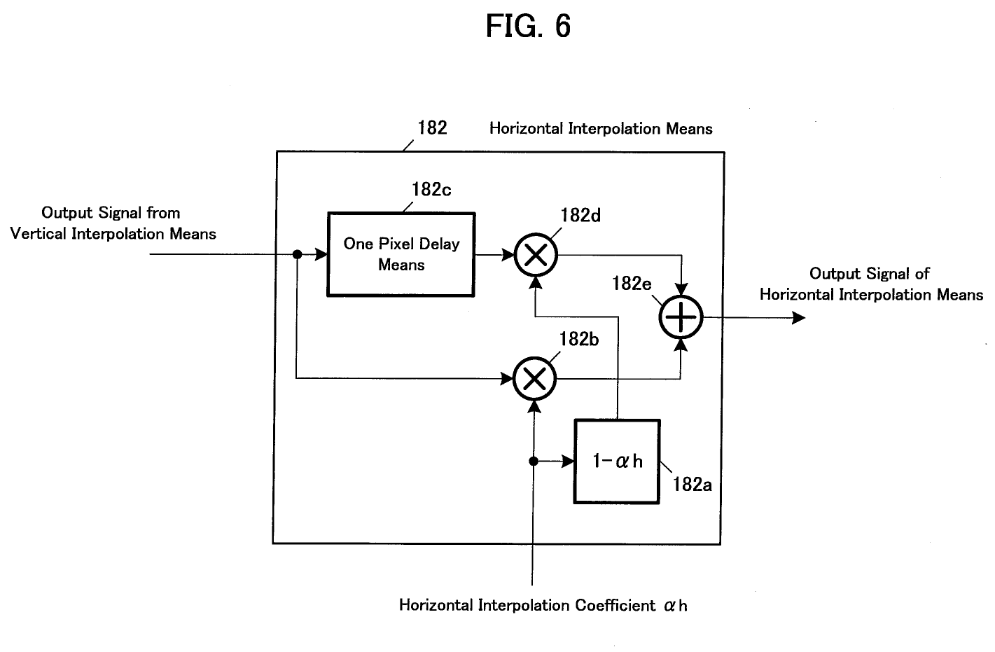

FIG. 6 is a block diagram showing, in further detail, the construction of the horizontal interpolation means 182. As shown in FIG. 6, the horizontal interpolation means 182 includes a calculating unit 182a for calculating a value 1−αh from an inputted vertical interpolation coefficient a h, a first multiplier 182b for multiplying the output signal from the Y/C signal processing means 15 by the vertical interpolation coefficient αv, pixel delay means 182c for delaying the output signal of the vertical interpolation means 181 by one pixel, a second multiplier 182d for multiplying the output signal from the pixel delay means 182c by the value 1−αh, and an adder 182d for adding the output of the first multiplier 182b to the output of the second multiplier 182d.

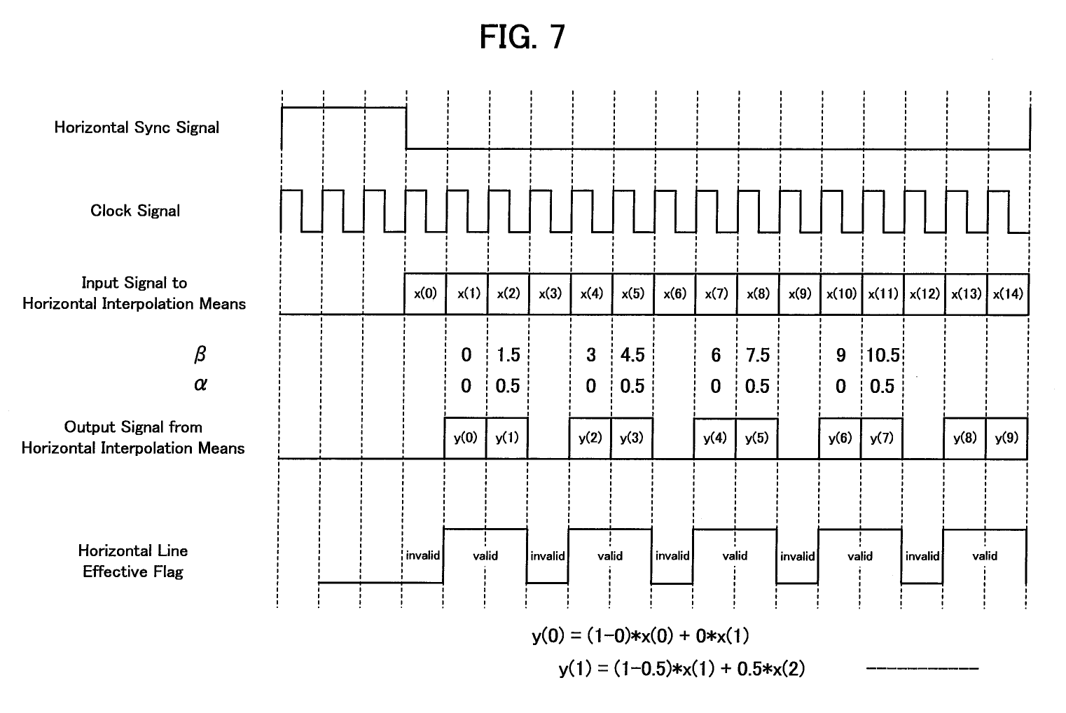

FIG. 7 is a timing chart showing, as one example of the operation to be performed at a vertical interpolation of ⅔ by the video signal processing apparatus, the horizontal sync signal, the clock signal, the input signal to be inputted into the horizontal interpolation means 182, the output signal of the horizontal interpolation means 182, and the horizontal effective flag. Here, the horizontal magnification of ⅔ is intended to indicate the ratio of the number of the output pixels of the horizontal interpolation means 182 to the number of the input pixels of the horizontal interpolation means 182. In FIG. 7, the fifteen effective pixels are defined by the period of the horizontal sync signal. Each of the effective pixels is processed in the period of the clock signal.

In FIG. 7, the reference characters x(0), x(1), . . . , x(14) are intended to indicate a sequence of pixels defined in a horizontal direction by the input signal to be inputted into the horizontal interpolation means 182. The reference characters y(0), y(1), . . . , y(9) are intended to indicate a sequence of pixels defined in a horizontal direction by the output signal of the horizontal interpolation means 182.

The horizontal interpolation means 182 is adapted to produce, on the basis of a following formula, the input signal x(i) (i=o, 1, 2, . . . , 14) from the output signal y(0) (j=0, 1, 2, . . . , 9).

y(j)=(1−αh)×x(int(βh))+αh×x(int(βh)+1)

Here, βh=j/horizontal magnification=j×3/2

αh=βh−int(βh)

In this embodiment, the horizontal interpolation means is adapted to perform the linear interpolating calculation by using two pixels. However, the horizontal interpolation means may be adapted to perform the high order interpolating calculation.

In this embodiment, the horizontal interpolation means 182 is adapted to receive the input signal x(int (j/horizontal magnification)+1) before computing the output signal y(i) in synchronization with the input signal x(int (j/horizontal magnification)+1). More specifically, it is not necessary to perform the horizontal interpolation over a period designated by the input signal x(int (j/horizontal magnification)+1).

It is necessary to indicate whether or not the output signal of the horizontal interpolation means 182 is effective. The horizontal zooming control means 172 is adapted to produce a horizontal effective flag for indicating whether or not the output signal W(j) of the vertical interpolation means 181 is effective.

The horizontal zooming control means 172 is adapted to receive a horizontal magnification, to calculate horizontal interpolation coefficients αh and βh on the basis of the horizontal magnification, to produce timing information on whether or not to have the horizontal interpolation means 182 perform the calculation of the output signal y(j), and to output the horizontal interpolation coefficient αv to the horizontal interpolation means 182. When the horizontal effective flag is in high level “H”, the horizontal effective flag indicates that the relevant pixel is recognized as an effective pixel. When, on the other hand, the horizontal effective flag is in low level “L”, the relevant pixel is recognized as an ineffective pixel.

The logical product circuit 173 of the zooming control means 17 is adapted to produce an effective flag signal by calculating the logical product of the vertical and horizontal effective flags.

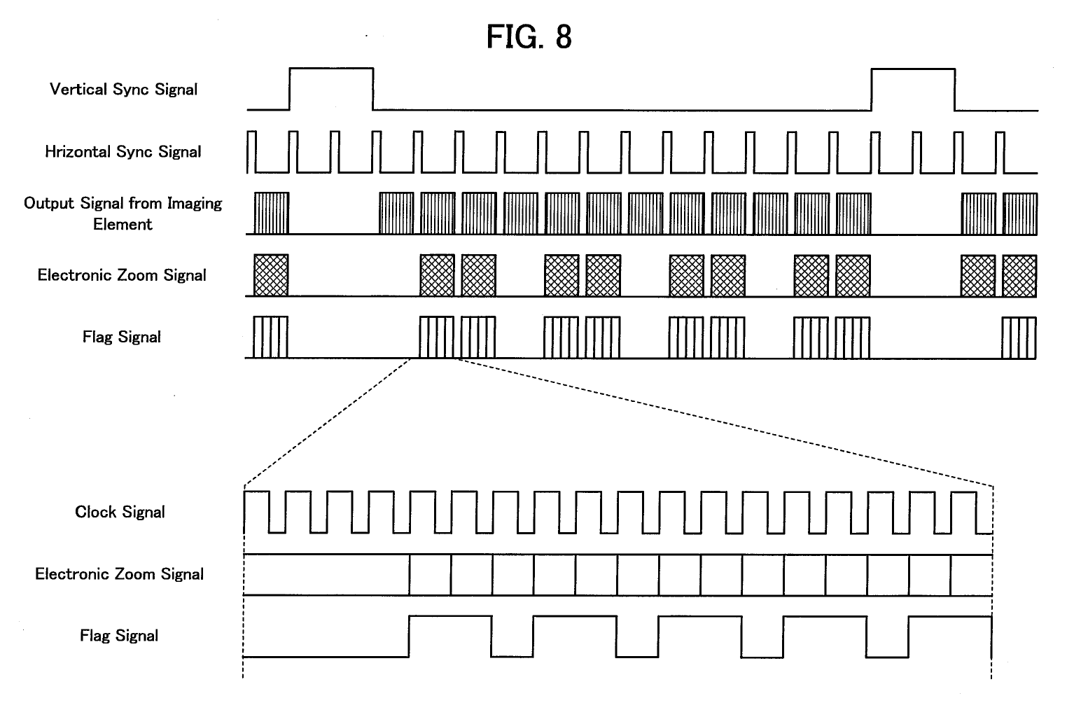

FIG. 8 is a timing chart showing the video signal (output signal) outputted by the imaging element 12 in synchronization with the horizontal and vertical sync signals, the output signal processed by the interpolating means 18, and the effective flag signal from the logical product circuit 173. As shown in FIG. 8, an external apparatus can extract the effective pixels from the electronically zoomed output signal and the effective flag signal received from the video signal processing apparatus, and produce an electronically zoomed image from the effective pixel information.

From the foregoing description, it will be understood that the video signal processing apparatus according to the first embodiment can be simple in construction, and can perform the electronic zooming function, without using a frame memory, by using a line memory by performing separately the horizontal and vertical electronic zooming functions, and performing the vertical interpolation process in each line.

Even if the horizontal and vertical magnifications are different from each other, the video signal processing apparatus can perform the electronic zooming process.

In this embodiment, the video signal processing apparatus is adapted to perform the horizontal interpolation after performing the vertical interpolation. However, the present invention is not limited to the order of the horizontal and vertical interpolations. Therefore the video signal processing apparatus may be adapted to perform the vertical interpolation after performing the horizontal interpolation. In this case, the line delay means 16 is defined between the vertical and horizontal interpolation computing means 181 and 182.

The line delay means may be constituted by line memory means having three banks, each of which writes a horizontal line forming part of an image represented by the video signal. In this case, the line memory means is adapted to write one horizontal line of the image in a bank selected in a predetermined order from among the banks. After the line memory means finishes writing one horizontal line in the third bank, the line memory means selects the first bank from among the banks, and overwrites the previously saved horizontal line of the first bank. The line memory means continues to perform the writing operation until writing all of the horizontal lines of the image in the banks. When the line memory means stores one horizontal line in any one of the banks, the line memory means is adapted to read out the previously saved horizontal lines from the remaining banks, and to output two horizontal lines read out from the remaining banks to the interpolating means. The interpolating means is adapted to perform, in each pixel, the vertical interpolation by using two horizontal line received from the line memory means.

### Second Embodiment

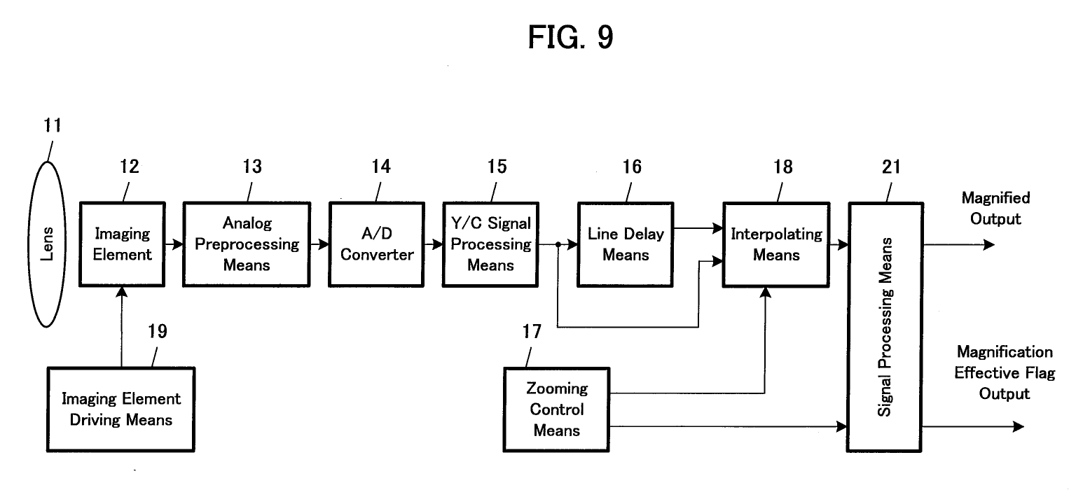

FIG. 9 is a block diagram showing the second embodiment of the video signal processing apparatus according to the present invention. The second embodiment of the video signal processing apparatus is almost the same in construction as the first embodiment of the video signal processing apparatus. Therefore, the constitution elements of the video signal processing apparatus according to the second embodiment substantially the same as those of the video signal processing apparatus according to the first embodiment will not be described but bear the same reference numbers as those of the video signal processing apparatus according to the first embodiment.

The video signal processing apparatus according to the second embodiment further comprises signal processing means 21 for performing the interpolation process on the electronically zoomed output signal of the interpolating means 18.

The signal processing means 21 includes line memory means 211 for storing the electronically zoomed output signal of the interpolating means 18 in response to write address banks, and reading out the output signals at the same time from two banks in response to read address banks, vertical interpolation computing means 212 for computing, on the basis of the vertical interpolation coefficient, the interpolation by using two output signals read from the line memory means 211, pixel memory means 213 for storing, one by one, each pixel of the output signal from the vertical interpolation computing means 212, horizontal interpolation computing means 214 for computing, on the basis of the vertical interpolation coefficient, the interpolation by using the output of the vertical interpolation computing means 212 and the output of the pixel memory means 213, vertical interpolation control means 215 for controlling the line memory means 211 and the vertical interpolation computing means 212 to have the vertical interpolation computing means 212 compute the interpolation, and horizontal interpolation control means 216 for controlling the horizontal interpolation computing means 214 to have the horizontal interpolation computing means 214 compute the interpolation.

The following description will be directed to the case that the interpolation is performed at double multiplication in the vertical direction by the signal processing means 21.

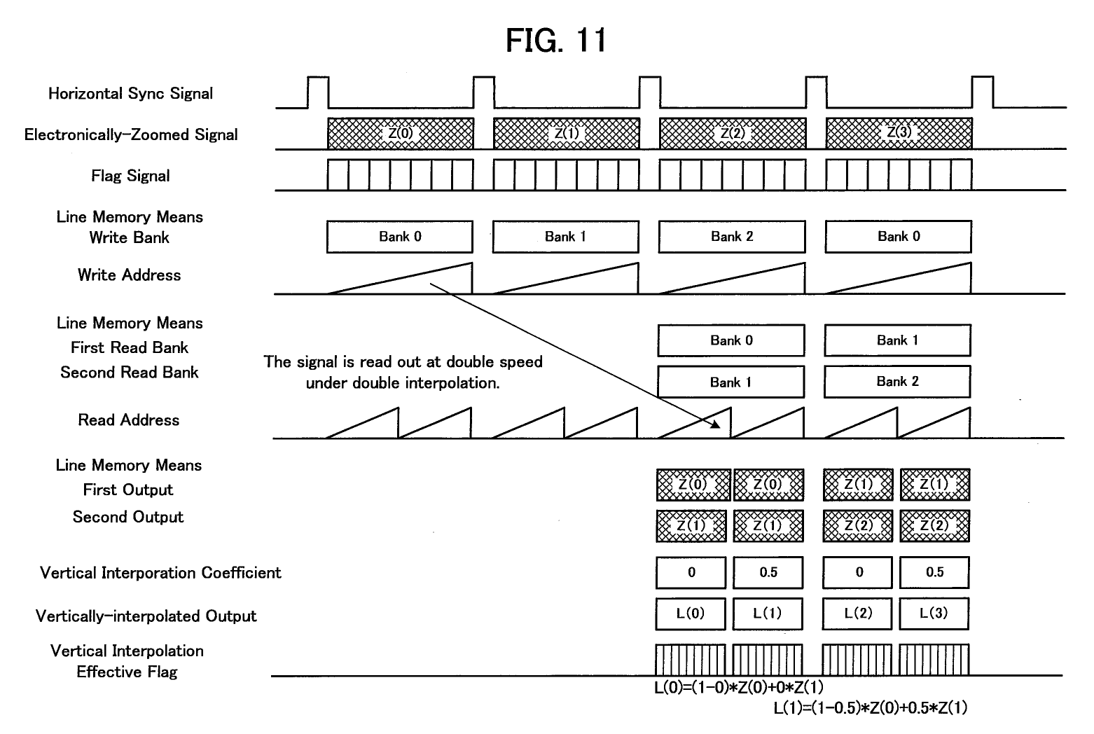

FIG. 11 is a timing chart showing an example of the interpolation to be performed at double speed at a vertical direction.

In FIG. 11, the reference characters Z(0), Z(1), . . . are intended to indicate electronically zoomed outputs of the interpolating means 18. The reference characters L(0), L(1), . . . are respectively intended to indicate the outputs of the vertical interpolation computing means 212.

The electronically zoomed outputs inputted into the signal processing means 21 is stored in the line memory means 211 in response to the write address banks outputted by the vertical interpolation control means 215.

The line memory means 211 has three banks that are selectively designated in each line. Each bank is adapted to output the signal before overwriting new signal.

When the interpolation is performed at a designated magnification of Nv (which is equal to 2 in FIG. 11), the video data is repeatedly read out, at a speed which is Nv times as fast as its writing speed, from two banks in which the video data have been already stored.

When the video data is repeatedly read out, in each line, from two of the banks Nv times a line, the i-th horizontal interpolation coefficient γv is defined by the following expression.

γv=(i−1)/Nv (i=1, 2, . . . , Nv)

The horizontal interpolation computing means 212 generates, on the basis of the following expression, the data L(0), L(1), L(2), . . . from two lines Z(j) and Z(j+1) (j=1, 2, . . . ) repeatedly read at the speed of Nv and the i-th horizontal interpolation coefficient γv.

L(j×Nv+i−1)=(1−γv)×Z(j)+γv×Z(j+1)

When the interpolation is performed at double multiplication as shown in FIG. 11, the first vertical interpolation coefficient=0, the second vertical interpolation coefficient=0.5.

Further, the effective flag is also stored in the line memory means 211. When the video data is read out at a speed of Nv, the effective flag is read out from the line memory means 211 as vertical interpolation effective flag.

The following description will be then directed to the case that the interpolation is performed at double magnification in a horizontal direction by the signal processing means 21.

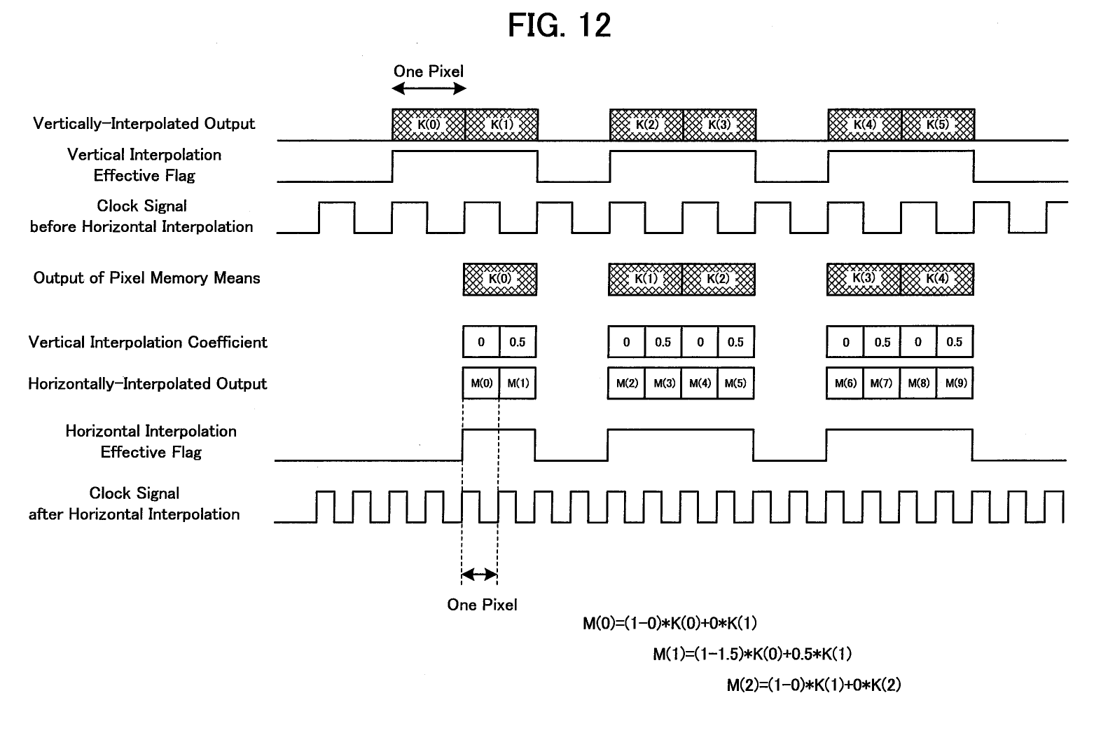

FIG. 12 is a timing chart showing as an example of the operation to be performed at double speed at a horizontal direction.

In FIG. 12, the reference characters K(0), K(1), . . . are intended to indicate pixels to be outputted to the horizontal interpolation computing means 214 from the vertical interpolation computing means 212. The reference characters M(0), M(1), . . . are intended to indicate output pixels of the horizontal interpolation computing means 214.

The vertically interpolated output of the vertical interpolation computing means 212 is inputted into the horizontal interpolation computing means 214 and the pixel memory means 213, and delayed by one pixel by the pixel memory means 213. The delayed output is inputted into the horizontal interpolation computing means 214.

When the interpolation is performed at a designated magnification of Nh (which is equal to 2 in FIG. 12), the horizontal interpolation computing means 214 performs the interpolation of Nh clock pulses (pixels) in response to the inputted clock pulse (each pixel), and outputs pixels at a speed which is Nh times as fast as original speed.

When the computation (interpolation) is repeatedly performed Nh times a pixel, the i-th horizontal interpolation coefficient γh is defined by the following expression.

γh=(i−1)/Nh (i=1, 2, . . . , Nh)

The horizontal interpolation computing means 214 generates, on the basis of the following expression, the data M(0), M(1), M(2), . . . from two pixels K(j) and K(j+1) (j=1, 2, . . . ) repeatedly read at the speed of Nh and the i-th horizontal interpolation coefficient γh.

M(j×Nh+i−1)=(1−γh)×K(j)+γh×K(j+1)

As shown in FIG. 12, the horizontal interpolation computing means 214 performs the interpolation by using the horizontal interpolation coefficient=0 in the first clock pulse, and the horizontal interpolation coefficient=0.5 in the second clock pulse.

From the foregoing description, it will be understood that the video signal processing apparatus according to the second embodiment can set an inputted magnification so as to zoom in and zoom out the image by reason that the signal processing means 21 is adapted to process the output of the interpolating means 18, the magnification of the apparatus being defined by the product of the magnification of the interpolating means and the magnification of the signal processing means.

### INDUSTRIAL APPLICABILITY OF THE PRESENT INVENTION

As will be seen from the foregoing description, the video signal processing apparatus according to the present invention can be reduced in production cost, has an advantageous effect of performing the electronic zooming function, and useful as an apparatus for carrying out the electronic zooming process on the video signal.

What is claimed is:

1. A video signal processing apparatus, comprising:
line delay means for delaying a video signal by a period of a horizontal scan; and
interpolating means for performing a vertical interpolation by using said video signal and said video signal delayed by said line delay means, performing a horizontal interpolation by using pixels adjacent to each other, and outputting an effective flag indicating an effective section of a signal to be outputted.

2. A video signal processing apparatus as set forth in claim 1, which further comprises signal processing means for performing a vertical interpolation by using at least two lines including a relevant line and an adjacent line, performing a horizontal interpolation by using pixels including a relevant pixel and an adjacent pixel, and outputting an effective flag indicating an effective section of a signal to be outputted.

3. A video signal processing apparatus, comprising:
video signal outputting means for outputting a video signal in synchronization with vertical and horizontal synchronization signals;
line delay means for delaying said video signal by a period of said horizontal synchronization signal;
interpolating means for performing a vertical pixel interpolation by comparing said video signal outputted by said video signal outputting means and said video signal delayed by said line delay means; and
zooming control means for controlling said interpolating means on the basis of a vertical magnification ratio to have said interpolating means perform said vertical pixel interpolation by using pixels vertically-adjacent in each pixel.

4. A video signal processing apparatus as set forth in claim 3, in which
said interpolating means is adapted to perform, for an image interpolated in said vertical direction, a horizontal pixel interpolation by using pixels horizontally-adjacent to each other, and
said zooming control means is adapted to control said interpolating means on the basis of a horizontal magnification to have said interpolating means perform said horizontal pixel interpolation by using two pixels horizontally-adjacent to each other.

5. A video signal processing apparatus as set forth in claim 3, in which said zooming control means is adapted to have said interpolating means perform said horizontal pixel interpolation by using pixels horizontally-adjacent to each other before said video signal is delayed by said line delay means.

6. A video signal processing apparatus as set forth in claim 4, in which
said interpolating means includes vertical interpolation means for producing a video signal indicative of said image interpolated in said vertical direction, and horizontal interpolation means for producing a video signal indicative of said image interpolated in said horizontal direction, and
said zooming control means includes vertical zooming control means for allowing a vertical line effective flag to indicate whether or not each of sample points of said video signal produced by said vertical interpolation means is within an active period, horizontal zooming control means for allow a horizontal line effective flag to indicate whether or not each of sample points of said video signal produced by said horizontal interpolation means is within an active period, and a logical product circuit for outputting, in synchronization with video signal produced by said horizontal interpolation means, an effective flag signal indicative of the logical product of said vertical and horizontal line effective flags.

7. A video signal processing apparatus as set forth in claim 6, in which
said vertical zooming control means is adapted to calculate a vertical interpolation coefficient from said vertical magnification ratio,
said vertical interpolation means includes a first multiplier for multiplying said video signal delayed by said line delay means by said vertical interpolation coefficient, a second multiplier for multiplying said video signal outputted by said video signal outputting means by a complement number of said vertical interpolation coefficient, and an adder for producing a video signal indicative of the sum of said video signal multiplied by said vertical interpolation coefficient and said video signal multiplied by said complement number of said vertical interpolation coefficient, and
said vertical zooming control means is adapted to allow said vertical interpolation means to output, in synchronization with said vertical and horizontal sync signals, said video signal produced by said adder to said horizontal interpolation means.

8. A video signal processing apparatus as set forth in claim 7, in which
said horizontal zooming control means is adapted to calculate a horizontal interpolation coefficient from said horizontal magnification,
said horizontal interpolation means includes pixel delay means for delay said video signal received from said vertical interpolation means, a first multiplier for multiplying said video signal received from said vertical interpolation means by said horizontal magnification coefficient, a second multiplier for multiplying said video signal delayed by said pixel delay means by a complement number of said horizontal magnification coefficient, and an adder for producing a video signal indicative of the sum of said video signal multiplied by said horizontal magnification coefficient and said video signal multiplied by said complement number of said horizontal magnification coefficient, and
said vertical zooming control means is adapted to allow said horizontal interpolation means to output, in synchronization with said vertical and horizontal sync signals, said video signal produced by said adder of said horizontal interpolation means.

9. A video signal processing apparatus as set forth in claim 3, in which
said line delay means is constituted by line memory means having three banks, each of which stores one line of an image to be represented by said video signal,
said line memory means is adapted to store said image in said three banks through steps of writing sequentially three lines of said image in said respective banks before overwriting sequentially the next three lines of said image in said respective banks, and overwriting repeatedly in each frame until writing the last line of said image is any one of said banks,
said line memory means is adapted to read, when writing one line of said image in any one of said banks, two lines from the remaining two banks, and to output said two lines to said interpolating means, and
said interpolating means is adapted to said vertical pixel interpolation by using two pixels of said two lines read by said line memory means.

10. A video signal processing apparatus as set forth in claim 9, in which said zooming control means is adapted to have said line memory means store said video signal after having said interpolating means perform said horizontal pixel interpolation by using pixels horizontally-adjacent to each other.
